(19) United States
(12) Patent Application Publication
(10) Pub. No.: US 2011/0163046 A1
(43) Pub. Date: Jul. 7, 2011

(54) Mobile UV Light Treatment Systems and Associated Methods

(76) Inventors: Kenneth G. Neal, Duncan, OK (US); Leonard R. Case, Duncan, OK (US); Lindsey M. Gloe, Duncan, OK (US)

(21) Appl. No.: 12/683,337

(22) Filed: Jan. 6, 2010

(51) Int. Cl. C02F 1/32

(52) U.S. Cl. 210/748.11; 210/205

(57) ABSTRACT

Of the methods provided herein, one includes a method comprising: providing a turbid treatment fluid having a first microorganism count; placing the turbid treatment fluid in a self-contained, road mobile UV light treatment manifold that comprises a UV light source; irradiating the turbid treatment fluid with the UV light source in the self-contained, road mobile UV light treatment manifold that comprises an attenuating agent so as to reduce the first microorganism count of the turbid treatment fluid to a second microorganism count to form an irradiated treatment fluid, wherein the second microorganism count is less than the first microorganism count; and placing the irradiated treatment fluid having the second microorganism count in a subterranean formation, a pipeline or a downstream refining process.

### CROSS REFERENCE TO RELATED APPLICATIONS

The present invention is related to co-pending U.S. application Ser. No. ______ [Attorney Docket No. HES 2008-IP-015929] entitled “UV Light Treatment Methods and System” filed concurrently herewith, the entire disclosure of which is incorporated herein by reference.

### BACKGROUND

The present invention relates to systems and methods of disinfecting treatment fluids, and more particularly, in certain embodiments, to methods of using a self-contained road mobile ultra violet (“UV”) light treatment fluid treatment system to treat biological contamination in treatment fluids used in well bore operations. The term “self-contained” as used herein means that the system includes its own power source, control system, and climate control system.

The presence of microorganisms, including bacteria, algae, and the like, in well treatment fluids can lead to contamination of a producing formation, which is undesirable. The term microorganism as used herein refers to living microorganisms unless otherwise stated. For example, the presence of anaerobic bacteria (e.g., sulfate reducing bacteria (“SRB”)) in an oil and/or gas producing formation can cause a variety of problems including the production of sludge or slime, which can reduce the porosity of the formation. In addition, SRB produce hydrogen sulfide, which, even in small quantities, can be problematic. For instance, the presence of hydrogen sulfide in produced oil and gas can cause excessive corrosion to metal tubular goods and surface equipment, and the necessity to remove hydrogen sulfide from gas prior to sale. Additionally, the presence of microorganisms in a viscosified treatment fluid can alter the physical properties of the treatment fluids by degrading the viscosifying polymer, leading to a decrease in viscosity, a possible significant reduction in treatment fluid productivity, and negative economic return.

Microorganisms may be present in well treatment fluids as a result of contaminations that are present initially in the base treatment fluid that is used in the treatment fluid or as a result of the recycling/reuse of a well treatment fluid to be used as a base treatment fluid for a treatment fluid or as a treatment fluid itself. In either event, the water can be contaminated with a plethora of microorganisms. In the recycle type of scenarios, the microorganisms may be more difficult to kill.

Biocides are commonly used to counteract biological contamination. The term “biological contamination,” as used herein, may refer to any living microorganism and/or by-product of a living microorganism found in treatment fluids used in well treatments. For well bore use, commonly used biocides are any of the various commercially available biocides that kill mircroorganisms upon contact, and which are compatible with the treatment fluids utilized and the components of the formation. In order for a biocide to be compatible and effective, it should be stable, and preferably, it should not react with or adversely affect components of the treatment fluid or formation. Incompatibility of a biocide in a well bore treatment fluid can be a problem, leading to treatment fluid instability and potential failure. Biocides may comprise quaternary ammonium compounds, chlorine, hypochlorite solutions, and compounds like sodium dichloro-s-triazinetrione. An example of a biocide that may be used in subterranean applications is glutaraldehyde.

Because biocides are intended to kill living organisms, many biocidal products pose significant risks to human health and welfare. In some cases, this is due to the high reactivity of the biocides. As a result, their use is heavily regulated. Moreover, great care is advised when handling biocides and appropriate protective clothing and equipment should be used. Storage of the biocides also may be an important consideration.

High intensity UV light has been used to kill bacteria in aqueous liquids. There are three UV-light classifications: UV-A, UV-B, and UV-C. The UV-C class is considered the germicidal wavelength, with the germicidal activity being at its peak at a wavelength of 254 nm. The rate at which UV light kills microorganisms in a treatment fluid is a function of various factors including, but not limited to, the time of exposure and flux (i.e., intensity) to which the microorganisms are subjected. For example, in a flow through cell type embodiment, a problem that may be associated with conventional UV light treatment systems is that inadequate penetration of the UV light into an opaque treatment fluid may result in an inadequate kill. Additionally, in such situations, to achieve optimal results, it is desirable to maintain the exposure to UV light at a sufficient flux for as long a period of time as possible to maximize the degree of penetration so that the biocidal effect produced by the UV light treatment may be increased. Another challenge is the turbidity of the treatment fluid. “Turbidity,” as that term is used herein, is the cloudiness or haziness of a treatment fluid caused by individual particles (e.g., suspended solids) and other contributing factors that may be generally invisible to the naked eye. The measurement of turbidity is a key test of water quality. The partial killing of the bacteria can result in the re-occurrence of the contamination, which is highly undesirable in the subterranean formation as discussed above.

Although high intensity UV light can be very beneficial in term's of preventing contamination, the conventional properties of such a UV light treatment fluid treatment system have significant drawbacks. One major problem associated with conventional UV light treatment systems is that such treatment systems are not mobile and the treatment fluid must be treated and then stored and transported off-site, thereby allowing contamination to re-occur prior to use.

### SUMMARY

The present invention relates to systems and methods of disinfecting treatment fluids, and more particularly, in certain embodiments, to methods of using a self-contained road mobile UV light treatment fluid treatment system to treat biological contamination in treatment fluids used in well bore operations.

In one embodiment, the present invention provides a method comprising: providing a turbid treatment fluid having a first microorganism count; placing the turbid treatment fluid in a self-contained, road mobile UV light treatment manifold that comprises a UV light source; irradiating the turbid treatment fluid with the UV light source in the self-contained, road mobile UV light treatment manifold that comprises an attenuating agent so as to reduce the first microorganism count of the turbid treatment fluid to a second microorganism count to form an irradiated treatment fluid, wherein the second microorganism count is less than the first microorganism count; and placing the irradiated treatment fluid having the second microorganism count in a subterranean formation, a pipeline or a downstream refining process.

In one embodiment, the present invention provides a method comprising: providing a turbid treatment fluid having a first microorganism count; placing the turbid treatment fluid in a self-contained, road mobile UV light treatment manifold that comprises a UV light source; irradiating the turbid treatment fluid with the UV light source in the presence of an attenuating agent to form an irradiated treatment fluid; and providing the irradiated treatment fluid to a mixing system

In one embodiment, the present invention provides a mobile UV light treatment fluid treatment system comprising: an inlet; a UV light treatment source; a UV light treatment chamber; an attenuating agent; an outlet; and wherein the UV light treatment fluid treatment system is transported by a self-contained, road mobile platform.

The features and advantages of the present invention will be readily apparent to those skilled in the art. While those skilled in the art may make numerous changes, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 illustrates a schematic of a self-contained, road mobile UV light treatment manifold.

FIG. 2 illustrates a schematic of a trailer with a self-contained, road mobile UV light treatment fluid treatment system.

FIGS. 3-8 illustrate data points discussed in the Examples section.

While the present invention is susceptible to various modifications and alternative forms, specific exemplary embodiments thereof has been shown by way of example in the drawing and are herein described in detail. It should be understood, however, that the description herein of specific embodiments is not intended to limit the invention to the particular form disclosed, but on the contrary, the intention is to cover all modifications, equivalents and alternatives falling within the spirit and scope of the invention as defined by the appended claims.

### DETAILED DESCRIPTION

The present invention relates to systems and methods of disinfecting treatment fluids, and more particularly, in certain embodiments, to methods of using a self-contained, road mobile UV light treatment fluid treatment system to treat biological contamination in treatment fluids used in well bore operations.

In some embodiments, the self-contained, road mobile UV light treatment fluid systems and methods disclosed herein may be utilized in any type of hydrocarbon industry application, operation, or process where it is desired to disinfect a turbid treatment fluid, including, but not limited to, pipeline operations, well servicing operations, upstream exploration and production applications, and downstream refining, processing, storage and transportation applications. The term “turbid treatment fluid” as used herein refers to a fluid having 1% to 90% transmittance at 254 nm, and in some instances, 50% to 90% transmittance at 254 nm.

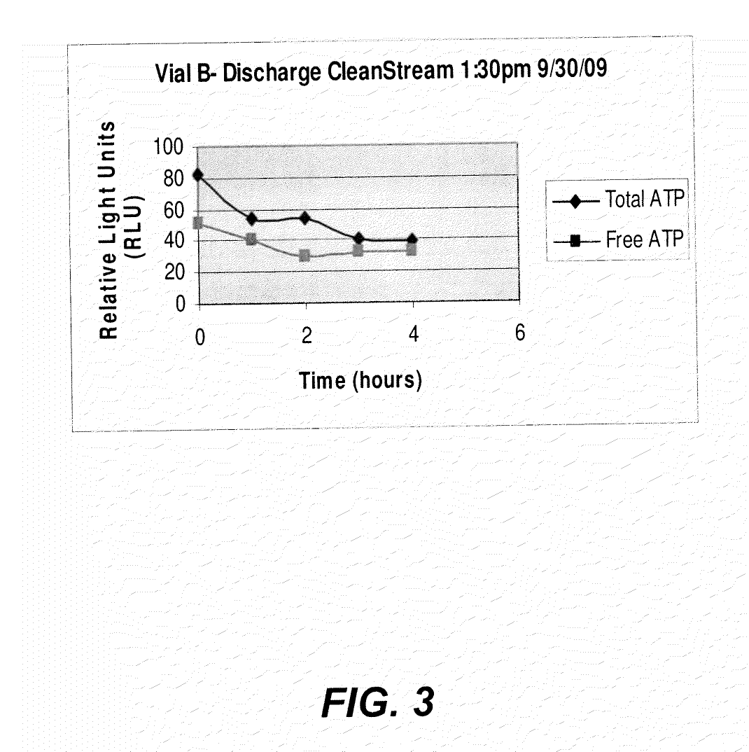

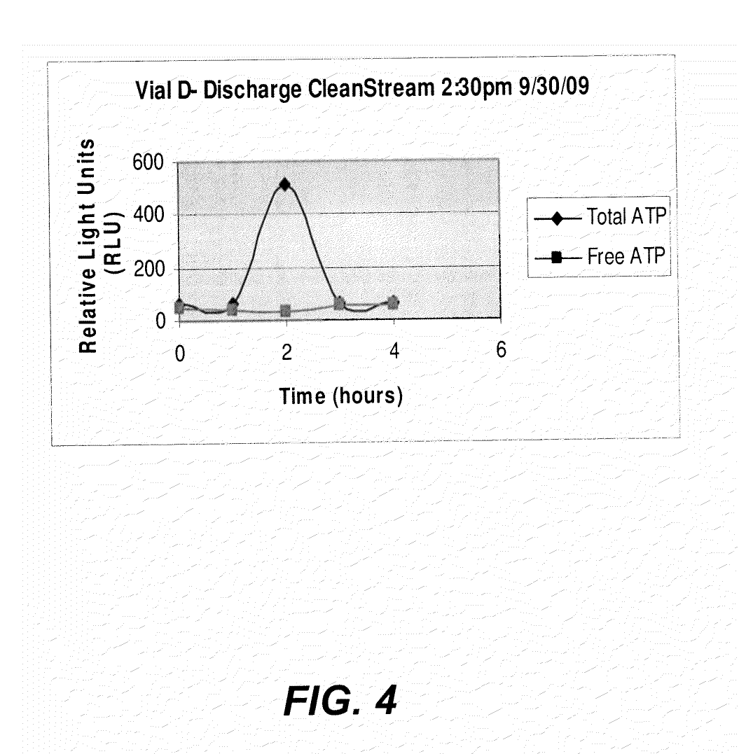

While not wanting to be limited by any particular theory, the cellular DNA of microorganisms absorbs the energy from the UV light, causing adjacent thymine molecules to dimerize or covalently bond together as illustrated in FIGS. 3 and 4. The dimerized thymine molecules are unable to encode RNA molecules during the process of protein synthesis. The replication of the chromosome before binary fission is impaired, leaving the bacteria unable to produce proteins or reproduce, which ultimately leads to the death of the organisms. This system oftentimes is most effective when treating waters with a low turbidity. Waters with high turbidity affect how the UV light photons transmit through the water. It is recommended that the treated water have at least 85% T (transmittance) measured at 254 nm in order to effectively kill the bacteria and pump at the max flow rate of 100 bpm.

The systems and methods disclosed herein may be useful for both aqueous-based, oil-based turbid treatment fluids, and combinations thereof. Suitable treatment turbid treatment fluids for the present invention may comprise virgin fluids (e.g., those that have not been used previously in a subterranean operation) and/or recycled fluids. Virgin fluids may contain water directly derived from a pond or other natural source. Recycled fluids may include those that have been used in a previous subterranean operation. In certain embodiments, the virgin fluids may be contaminated with a plethora of microorganisms, having an initial microorganism count in the range of about 10³ bacteria/mL to about to 10³⁰ bacteria/mL. In some embodiments, 10¹⁰ bacteria/mL or greater may be common. Recycled fluids may be similarly contaminated as a result of having been previously used in a subterranean formation or stored on-site in a contaminated tank or pit. Recycled fluids may have a first microorganism count in the same range, but it may have a different bacterial contamination in that it may comprise different bacteria that are harder to kill than those that are usually present in virgin fluids.

In addition to reducing the amount of contamination in oil field operations, the methods disclosed herein may allow for a reduction in the amount of chemical biocides used, leading to improved economic return and production of an environmentally safe treatment fluid, at least under current (as of the time of filing) environmental standards and regulations. Elimination or reduction of such harmful biocides may additionally reduce injuries on location. Further, the present invention describes a self-contained, road mobile UV light system, thereby diminishing the cost of transferring treated water to a remote location such as a well site. Further, the present invention provides a system capable of treating large quantities of a turbid treatment fluid on-site, improving the ability to reclaim and re-use the scarce water found in such remote locations.

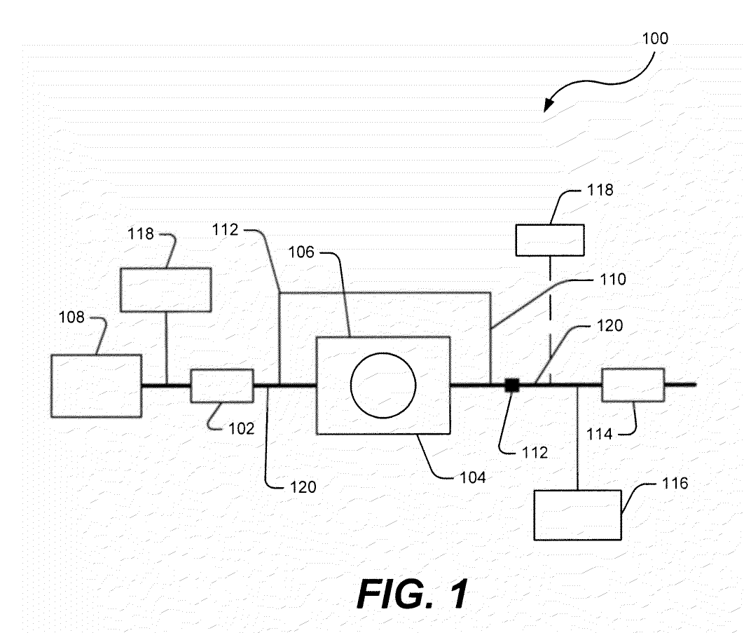

Referring to FIG. 1, a self-contained, road mobile UV light treatment manifold is shown generally at 100 that may be used to disinfect turbid treatment fluids, including those used in well bore operations. As used herein, the term “disinfect” and its derivatives shall mean to reduce the number of bacteria and/or other microorganisms found in a turbid treatment fluid. As shown in FIG. 1, a self-contained, road mobile UV light treatment manifold 100 may comprise one or more inlets 102; one or more UV light treatment sources 104 that are contained within one or more UV light treatment chambers 106; a turbid treatment fluid supply source 108; optionally one or more bypass manifolds 110; optionally one or more air vents 112; and one or more outlets 114. Optionally, the turbid treatment fluid may be pretreated (e.g., to remove solids, debris, and the like) prior to being placed in the UV light treatment chamber (e.g., before inlet 102). The turbid treatment fluid supply source 108 may comprise a number of fluids including virgin fluids, recycled fluids, natural fluids (e.g., from ponds), oil-based fluids, and the like. An optional pretreatment stage is shown at 118 in FIG. 1. This pretreatment stage, in some embodiments, may involve the addition of an optional biocide if the contamination in the fluid is such that this would be useful. Preferably, this pre-treatment may occur upstream of the irradiation process that occurs when the treatment fluid reaches the UV light treatment source 104, thereby enhancing the treatment process by, inter alia, reducing turbidity in the treatment fluid. Optionally, inlet 102 may comprise a device that imparts turbulence to the fluid to disperse microoganisms within the turbid treatment fluid and prevent the formation of a biofilm in the fluid. In particular, the UV light treatment source 104 within the UV light disinfection chambers 106 should penetrate a filtered treatment fluid more effectively than through a debris-laden treatment fluid, and some removal of biological material upstream of the UV light treatment source 104 may enhance the efficiency of the UV light treatment. The inlet 102 may draw treatment fluid from the turbid treatment fluid before passing it through the UV light treatment source 104 to be irradiated. The term “irradiated” or “irradiating,” as used herein, generally refers to the process by which the treatment fluid is exposed to UV radiation for the purposes of disinfecting a turbid treatment fluid.

After irradiation, optionally, the irradiated treatment fluid may then be passed to a mixing system 116, where it may be combined with additives such as gelling agents, proppant particulates, gravel particulates, friction reducing agents, corrosion inhibitors, as well as other chemical additives to form a blended slurry. Mixing system 116 may comprise a blender for fracturing fluids. The mixing system may comprise a pump, such as a suction pump, that can be used to facilitate the movement of the turbid treatment fluid through the UV light treatment chamber 106. In some embodiments, such chemical additives may be blended with the treatment fluid before it is moved to a pump. The treatment fluid may then move through the outlets 114 to wellhead and downhole to perform a desired subterranean operation.

In another embodiment, the turbid treatment fluid may be passed through the UV light treatment source 104 directly to a pump(s) 118. Pumps suitable for use in the present invention may be of any type suitable for moving treatment fluid and compatible with the treatment fluids used. In some embodiments, the pump may be a high-pressure pump, which may pressurize the treatment fluid. In some embodiments, the pumps may be staged centrifugal pumps, or positive displacement pumps, but other types of pumps may also be appropriate. The treatment fluid may then move through the outlets 114 to wellhead and downhole to perform a desired subterranean operation.

In some embodiments, where a mixing system is used after a pump, by providing for the addition of proppant particulates, gels and any other suitable chemical additives after the treatment fluid has passed through the pumps, life expectancy and reliability of the pumps may improve, and maintenance costs may diminish over traditional methods involving erosive and abrasive forces caused by proppant-laden treatment fluids passing through dirty pumps. Additionally, this method may allow for independent optimization of operations. In other words, in some embodiments, an operator may separately optimize the high-pressure pumping operations and abrasive additive operations. Filters suitable for use in the present invention may comprise a variety of different types of filters, depending upon the requirement of the operation, including sock filters, boron removal filters, micron particle filters, activated charcoal filters, and any other type of filter to make the treatment fluid suitable for the intended operation.

In an alternative embodiment, optionally the turbid treatment fluid may be passed through a bypass manifold 110, bypassing the UV light treatment source 104, directly to the pump 118. Optionally, a biocide may be placed in the fluid through a chemical biocide injection pump shown at 120. This type of pump may also precede the manifold 106. This embodiment may be desirable when the turbidity of the fluid is too high for UV light disinfection. In such embodiments, optionally biocides may be added at inlet 102 or outlet 114 to control contamination. The chemically treated treatment fluid may then move through outlet 114 to the wellhead and downhole to perform the desired operation. In certain embodiments, the turbid treatment fluid may be treated by both the UV light treatment source and chemical biocides. This method may allow for a more powerful disinfection and effective treatment of more serious contaminations.

In another embodiment, a static fluid mixer and/or a turbulator may be used in the UV light treatment source 104 (FIG. 1) if desired to increase fluid movement to aid greater exposure to the UV light source.

In some embodiments, the UV light treatment source 104 may comprise one or more germicidal UV light sources in a series or in parallel. Low to medium-pressure germicidal UV lamps may be suitable. Ultraviolet light is classified into three wavelength ranges: UV-C, from about 200 nanometers (nm) to about 280 nm; UV-B, from about 280 nm to about 315 nm; and UV-A, from about 315 nm to about 400 nm. Generally, UV light, and in particular, UV-C light is germicidal. Germicidal, as used herein, generally refers to reducing or eliminating bacteria and/or other microorganisms. Specifically, while not intending to be limited to any theory, it is believed that UV-C light causes damage to the nucleic acid of microorganisms by forming covalent bonds between certain adjacent bases in the DNA. The formation of these bonds is thought to prevent the DNA from being “unzipped” for replication, and the organism is unable to produce molecules essential for life process, nor is it able to reproduce. When an organism is unable to produce these essential molecules or is unable to replicate, it dies. It is believed that UV light with a wavelength of approximately between about 250 nm to about 260 nm provides the highest germicidal effectiveness. While susceptibility to UV light varies depending on volume and treatment fluid properties, exposure to UV energy of about 60,000 watts may be adequate to deactivate over 90 percent of microorganisms. In some embodiments, each light bulb used in the present invention has a UV energy of about 1700 watts to about 3800 watts.

In some embodiments, to enhance the disinfection of a treatment fluid, attenuating agents may be used in combination with a UV light source to decrease the necessity of long and repeated exposures to high power UV lights. The attenuating agents are thought to effectively prolong the effect of the UV light and its reaction with the microorganisms. It is well understood that, when attenuating agents are exposed to a UV light source, even at low levels, they photoisomerize to release free radicals. The free radicals may then act to decompose microorganisms (e.g., bacterial membranes) within the treatment fluid. In addition, longer biocidal action should be realized at least in most embodiments by selecting the appropriate free-radical-forming material based on solubility, reactivity and free radical half-life. Additionally, the UV light treatment fluid treatment systems of the present invention should effectively generate long-lasting free radicals so that even after the treatment, biocidal action may be stimulated in the treatment fluids used in well treatments, thus continuing to kill bacteria, and remove contamination to recover production in formations.

Suitable attenuating agents for use in the treatment fluids and methods of the present invention include organic and inorganic attenuating agents. The solubility and/or dispersability of an attenuating agent may be a consideration when deciding whether to use a particular type of attenuating agent. Some of the attenuating agents may be modified to have the desired degree of solubility or dispersability. Cost and environmental considerations might also play a role in deciding which to use. In addition, the method of use in the methods of the present invention may be a factor as well. For example, some methods may call for a less soluble agent whereas others may be more dependent on the solubility of the agent in the treatment fluid. The particular attenuating agent used in any particular embodiment depends on the particular free radical desired and the properties associated with that free radical. Some factors that may be considered in deciding which of the attenuating agents to use include, but are not limited to, the stability, persistence and reactivity of the generated free radical. The desired stability also depends on the amount of contamination present and the compatibility the free radicals have with the treatment fluid composition. To choose the right attenuating agent for treatment, one should balance stability, reactivity and incompatibility concerns. Those of ordinary skill in the art with the benefit of this disclosure will be able to choose an appropriate attenuating agent based on these concerns.

Suitable organic attenuating agents for use in the present invention, include, but are not limited to, one or more water-soluble photoinitiators that undergo cleavage of a unimolecular bond in response to UV light and release free radicals. Under suitable conditions and appropriate exposure to UV light, the attenuating agents of the present invention will yield free radicals, such as in the example of Scheme 1 below:

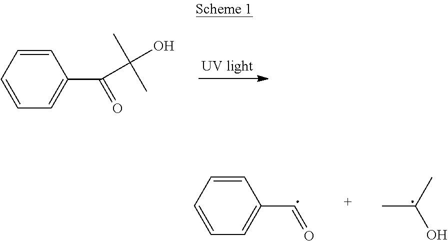

Suitable attenuating agents may be activated by the entire spectrum of UV light, and may be more active in the wavelength range of about 250-500 nm. The molecular structure of the attenuating agent will dictate which wavelength range will be most suitable. Some attenuating agents undergo cleavage of a single bond and release free radicals. Each organic attenuating agent has a life span that is unique to that attenuating agent. Generally, the less stable the free radical formed from the attenuating agent the shorter half-life and life span it will have.

Suitable organic attenuating agents for use in the present invention may include, but are not limited to, acetophenone, propiophenone, benzophenone, xanthone, thioxanthone, fluorenone, benzaldehyde, anthraquinone, carbazole, thioindigoid dyes, phosphine oxides, ketones, and any combination and derivative thereof. Some attenuating agents include, but are not limited to, benzoinethers, benzilketals, alpha-dialkoxyacetophenones, alpha-hydroxyalkylphenones, alpha-aminoalkylphenones, and acylphosphineoxides, any combination or derivative thereof. Other attenuating agents undergo a molecular reaction with a secondary molecule or co-initiator, which generates free radicals. Some additional attenuating agents include, but are not limited to, benzophenones, benzoamines, thioxanthones, thioamines, any combination or derivative thereof. These materials may be derivatized to improve their solubility with a suitable derivatizing agent. Ethylene oxide, for example, may be used to modify these attenuating agents to increase their solubility in a chosen treatment fluid. Such attenuating agents may absorb the UV light and undergo a reaction to produce a reactive species of free radicals (See Scheme 1, for instance) that may in turn trigger or catalyze desired chemical reactions.

In certain embodiments, free radicals released through the activation of attenuating agents initiate damage to living microorganisms. In certain embodiments, the mode of action for the attenuating agents may be the interaction of the released free radicals with the microorganisms so as to disrupt the cellular structures and processes of the microorganism. In some instances, the biocidal effect due to prolonged life associated with each free radical is thought to increase with increasing free radical stability and reactivity. For certain aspects of the present invention, it may be important to consider the life span or half-life of the free radicals that will result. Some free radicals may be very active even though they have short life span. Some free radicals may be more active in the presence of the UV light whereas some may retain the activity even outside direct exposure to the UV light. The term “half-life” as used herein refers to the time it takes for half of the original amount of the free radicals generated to decay. The term “life span” refers to the total time for the free radical to decay almost completely. For instance, a free radical with a longer half-life will result in a longer lasting biocidal effect, limiting the need for UV light exposure and therefore, may be more useful in treatment fluids having a high turbidity.

Alternatively, inorganic attenuating agents may be used in certain embodiments. When exposed to UV light, these agents will generate free radicals that will interact with the microorganisms as well as other organics in a given treatment fluid. In preferred embodiments, these may include nanosized metal oxides (e.g., those that have at least one dimension that is 1 nm to 1000 nm in size). In some instances, these inorganic nanosized metal oxide attenuating agents may agglomerate to form particles that are micro-sized. Considerations that should be taken into account when deciding the size that should be chosen include a balance of surface reactivity and cost. Examples of suitable inorganic attenuating agents include, but are not limited to, nanosized titanium dioxide, nanosized iron oxides, nanosized cobalt oxides, nanosized chromium oxides, nanosized magnesium oxides, nanosized aluminum oxides, nanosized copper oxides, nanosized zinc oxides, nanosized manganese oxides, and any combination or derivative thereof. Titanium dioxide, for example produces hydroxyl radicals upon exposure to UV light. These hydroxyl radicals, in one mechanism, are very useful in combating organic contaminants. These reactions can generate CO₂. Nanosized particles are used because they have an extremely small size maximizing their total surface area and resulting in the highest possible biocidal effect per unit size. As a result, nanosized particles of metal oxides provide a higher enhancement of kill rate efficiency than larger particles used in much higher concentrations. An advantage of using such nanosized metal oxide particles in combating contamination is that the treated microorganisms cannot acquire resistance to such metal particles, as commonly seen with other biocides.

In some embodiments, a thin film of an inorganic attenuating agent may be used within a UV apparatus. In such instances, the inorganic attenuating agent may be crystalline. Techniques that may be used to form such films include, but are not limited to, chemical vapour deposition techniques, pulsed laser deposition technique, reactive sputtering and sol-gel deposition processes, and/or dip-coating processes. In other embodiments, the inorganic attenuating agent may be incorporated within a polymeric film in an amount up to a certain desired weight %. The polymeric film may comprise polyurethane. Techniques that may be used to form such films may include any suitable technique including, but not limited to, sol-gel techniques. The weight % could be anywhere from a very low number (close to zero) up to 80% or more, depending on what is deemed to be useful without causing undue expense. Depending on where the film is located within the apparatus, the film may or may not be transparent. Both types of films discussed above may be transparent, in some instances. For instance, if the film is placed on the quartz sleeve which encases the UV bulb, it would be desirable to have the film be transparent so that the UV light is able to pass through the film and interact with the fluid. In yet other embodiments, the inorganic attenuating agents can be added as solid particles to a treatment fluid. In other embodiments, the inorganic attenuating agents may be used in a suspension form, e.g., in water. This might be useful when it is desirable to coat an element of a UV device in which the UV light will be used. In an alternative embodiment, a thin film of the nanosized metal oxide may be placed on the UV apparatus (e.g., on the interior of the UV light manifold, on the quartz sleeve surrounding the UV light bulbs, etc.) that is being used in a given system. The thin film may be made from a suitable polymer wherein the inorganic attenuating agent has been deposited. In other embodiments, the inorganic attenuating agent may be deposited on a portion of the UV apparatus through a vapor deposition technique. An advantage of using inorganic attenuating agents in such a manner is that the system becomes self-cleaning.

The concentration of the nanosized metal oxide in the film used in the present invention may range up to about 0.05% to 10% by weight of the film by dry weight. The particular concentration used in any particular embodiment depends on what free radical compound is being used, and what percentage of the treatment fluid is contaminated. Other complex, interrelated factors that may be considered in deciding how much of the nanosized metal oxides to include, but are not limited to, the composition contaminants present in the treatment fluid (e.g., scale, skin, calcium carbonate, silicates, and the like), the particular free radical generated, the expected contact time of the formed free radicals with the bacteria, etc. The desired contact time also depends on the amount of contamination present and the compatibility the free radicals have with the treatment fluid composition. For instance, to avoid incompatibility, it may be desirable to treat the water source prior to mixing in with the other components of the treatable treatment fluids. A person of ordinary skill in the art, with the benefit of this disclosure, will be able to identify the type of nanosized metal oxides as well as the appropriate concentration to be used.

In some embodiments, a thin film of pure titanium dioxide may be used in the UV apparatus of the present invention. Techniques that may be used to form such films include, but are not limited to, chemical vapour deposition techniques, pulsed laser deposition techniques, reactive sputtering and sol-gel deposition processes, and/or dip-coating processes. In other embodiments, the pure titanium dioxide may be incorporated within a polymeric film in an amount up to a certain desired weight %. The polymeric film may comprise polyurethane. Techniques that may be used to form such films may include any suitable technique including, but not limited to, sol-gel techniques. The weight % could be anywhere from a very low number (close to zero) up to 80% or more, depending on what is deemed to be useful without causing undue expense. Depending on where the film is located within the apparatus, the film may or may not be transparent. Both types of films discussed above may be transparent, in some instances. For instance, if the film is placed on the quartz sleeve which encases the UV bulb, it would be desirable to have the film be transparent so that the UV light is able to pass through the film and interact with the fluid

The concentration of the attenuating agent used in the treatment fluids of the present invention may range up to about 5% by weight of the turbid treatment fluid. The particular concentration used in any particular embodiment depends on what free radical compound is being used, and magnitude of contamination is present in the turbid treatment fluid. Other complex, interrelated factors that may be considered in deciding how much of the attenuating agent to include, but are not limited to, the composition contaminants present in the turbid treatment fluid (e.g., scale, skin, calcium carbonate, silicates, and the like), the particular free radical generated, the expected contact time of the formed free radicals with the bacteria, etc. The desired contact time also depends on the amount of contamination present and the compatibility the free radicals have with the turbid treatment fluid composition. For instance, to avoid incompatibility, it may be desirable to treat the water source prior to mixing in with the other components of the turbid treatment fluid. A person of ordinary skill in the art, with the benefit of this disclosure, will be able to identify the type of attenuating agents as well as the appropriate concentration to be used.

Many attenuating agents are liquids, and can be made to be water-soluble or water insoluble. Similarly, attenuating agents may exist in solid form, and can be made to be water-soluble or water-insoluble.

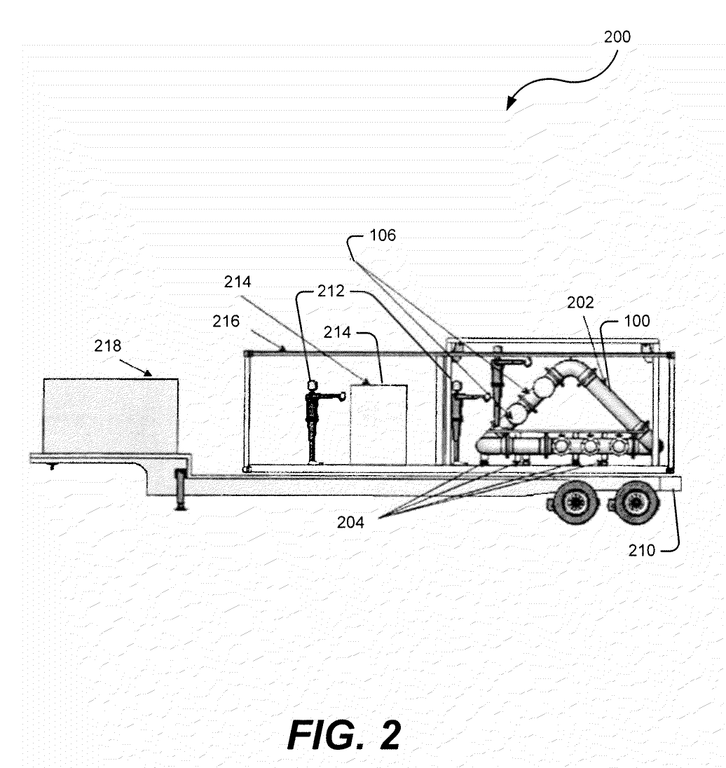

FIG. 2 schematically depicts a self-contained, road mobile UV light fluid treatment system 200 utilizing a trailer 210 to transport the self-contained, road mobile UV light treatment manifold 202. Trailer 210 may comprise a trailer, a skid, a truck, a shipping container, or any other suitable self-contained, road mobile platform. An advantage of having the system of the present invention be mobile is that it can replicate indoor conditions such as that that would be found in a factory, a large ship, or water treatment plant. This includes climate control systems and protection from outdoor elements. Additionally, because of the self-contained aspect of the road mobile UV light fluid treatment system of the present invention, another advantage is that the system can be free of voltage spikes in power and protected from vibrations as compared to other systems.

An operator, shown for example at 212, may choose any of a number of methods to disinfect a turbid treatment fluid. In some embodiments, a control panel 214 will indicate conditions where effective UV light disinfection is not possible. In such embodiments, an option bypass manifold 110 and optional chemical biocides may be used. Biocides may be useful to control downstream contamination. The control panel 214 may be enclosed in an optional container 216 to protect both the operator 212 and the equipment from the environmental elements. In some embodiments, the container 216 may be climate controlled. In some embodiments, the container 216 may also include the self-contained, road mobile UV light treatment manifold 100, optionally mounted to the container 216 with isolation mounts 204, e.g., to prevent vibrations from damaging the fragile UV light bulbs. Still referring to FIG. 2, the self-contained, road mobile UV light treatment manifold 100 may comprise one or more UV treatment chambers 106 in series or in parallel. In addition the mobile UV light fluid treatment system 200 may comprise a power supply. One of ordinary skill in the art will readily appreciate that the power supply may be any suitable power source. For instance, the equipment may be powered by a generator, a combustion engine, an electric power supply or by a hydraulic power supply.

In some embodiments, when a fracturing operation is conducted in the well bore, flowback treatment fluid may be produced comprising a mixture of formation treatment fluid and fracturing treatment fluid. The flowback treatment fluid may be recovered from the well bore and conveyed through pre-treatment filters by a pump. The pre-treated treatment fluid may then be passed through the UV light fluid treatment system of the present invention. In some embodiments, pumps may control the speed by which the treatment fluid moves through the system, and in particular, through the UV light treatment chambers 106 in order to optimize the disinfection. In some embodiments, suitable speeds for the turbid treatment fluids passing through the self-contained, road mobile UV light treatment manifold may be in the range of from about 20 barrels per minute to about 120 barrels per minute. In certain exemplary embodiments, the speed of the turbid treatment fluid passing through the self-contained, road mobile UV light treatment manifold may be in the range of from about 50 barrels per minute to about 120 barrels per minute.

Susceptibility to UV light varies depending on the turbidity, flowrate and volume of the water, as well as the intensity and flux of the UV light. Treatment fluids used for fracturing and other oilfield applications may generally have high turbidity, leading to lower rates of disinfection when passed through UV light treatment systems of the current invention. Thus, in some embodiments, the flowrate may be adjusted according to the turbidity of the treatment fluid in order to obtain an acceptable reduction of the bacteria and microorganisms found in the treatment fluids. In one embodiment, a UV light fluid treatment system may be used as an initial shock treatment to get an immediate reduction in the number of microorganisms present in the turbid treatment fluid. Once the initial shock treatment is completed, then small quantities of chemical biocides may be added to complete the disinfection. In certain embodiments, subsequent shock treatments may also be used to further reduce the amount of biocide necessary. In other embodiments, the initial UV light fluid treatment system may be used as an initial shock treatment to disinfect the equipment prior to use.

In certain embodiments of the present invention, chemicals may be added to the turbid treatment fluid before it is irradiated to decrease turbidity and increase the effectiveness of the UV light treatment. Such chemicals may include attenuating agents. The particular amount of UV exposure used in any particular embodiment depends on the turbidity of the contaminated treatment fluid and the magnitude of contamination present in the turbid treatment fluid. The irradiated treatment fluid may then be directed to an outlet for disposal to the environment or re-use in another operation. Suitable outlets may be any type of outlet, including valves used to direct treatment fluid flow and which are compatible with treatment fluids used in the specific operation. Alternatively, instead of re-using the irradiated treatment fluid at the same well site, the treatment fluid may be hauled by truck or transported by other means for re-use at a remote well site. If diverted for disposal, the control panel 214, may ensure that the irradiated treatment fluid is safe before it is released to the environment, which may be a water source, e.g., river or lake; a land surface; or injected into a disposal well.

If the irradiated treatment fluid is diverted for re-use, additives such as gelling agents, proppant particulates, and other treatment fluid components may be added to produce the treatment fluid. The treatment fluid may then be introduced into the well bore to conduct a fracturing operation or other desired subterranean operation.

To facilitate a better understanding of the present invention, the following examples of certain aspects of some embodiments are given. In no way should the following examples be read to limit, or define, the entire scope of the invention.

### Example

The following discusses representative examples.

Procedure. Serial Dilution. Water samples are taken at various times during the UV system testing. Serial dilutions are then performed using the water in aerobic pheol red media vials (available from VW Enterprises #BB-PR) and anaerobic sulfate reducing (available from VW Enterprises ##BB-AR). The aerobic phenol red vials turn from red to yellow in the presence of bacteria, while the anaerobic sulfate reducing vials form a black iron sulfide precipitate.

The procedure is as follows. First, the eight media vials are labeled numbers 1 through 8 (more or less vials may be necessary depending on the water you are testing). The protective cap is removed from the vials. A 1 ml sterile syringe is removed from its plastic container and a sterile needle is attached (20 G 1½ in). The tip of the needles is immersed in the water sample and the syringe is filled to 1 ml (no air is trapped in the syringe). The needle is then inserted into vial #1 and the solution is injected into the bottle. The aerobic phenol red media vials (available from VW Enterprises #BB-PR) and the anaerobic sulfate reducing vials (available from VW Enterprises ##BB-AR) are used for the testing. Without pulling out the syringe, the syringe is filled 4 more times with the solution from the vial and purged back into the vial. Without pulling out the syringe, the vial is shaken to mix the broth with the injection water. The syringe is then filled two more times and purged back into the vial. A 1 ml sample is then withdrawn from the first vial into the syringe and injected into the second vial. This process is continued to draw 1 ml samples from each vial until the last vial is inoculated. The vials are then placed in an incubator at 37° C. and observed for a minimum of 72 hours. The number of bottles showing positive results within the allotted time period can be used to calculate the bacteria level in the original sample. This is illustrated by the number of vials showing bacterial growth in the serial dilutions, shown in Table 1. Vials that show a positive result for bacteria, but are not in a sequence, beginning with the first vial can be excluded as they are considered experimental error. If the nail has a black coating (iron sulfide) in the VW Enterprises #BB-AR vials, this is also considered a positive result for SRBs.

TABLE 1

| Number of Positive | Estimated Bacteria/cc of |
|---|---|
| Bottles | Original Sample |
| 0 | 0 |
| 1 | 10¹ |
| 2 | 10² |
| 3 | 10³ |
| 4 | 10⁴ |
| 5 | 10⁵ |
| 6 | 10⁶ |
| 7 | 10⁷ |
| 8 | 10⁸ |

Vials that show a positive result for bacteria, but are not in a sequence, beginning with the first vial can be excluded as they are experimental error.

If the nail has a black coating (iron sulfide) in the VW Enterprises #BB-AR vials, this is also considered a positive result for SRBs.

ATP Detection. The 3M Biomass Detection Kit contains vials of reagent for the detection of Adenosine Tri-Phosphate (ATP) in liquid samples. A sample is placed in a cuvette together with extractant to release the ATP from microorganisms in the sample. After 1 minute of extraction the re-hydrated reagent is added to the vial to react with the sample ATP to produce light. The intensity of the light is proportional to the amount of ATP and therefore the degree of contamination. Measurement of the light requires the use of a 3M Luminometer and the results are displayed in Relative Light Units (RLU).

Preparation for Testing. A sufficient number of each component A, B and Extractant XM (1 each for 10 tests or 2 for 20 tests etc.) are removed from the pack for the number of tests to be performed. The remainder of the kit is returned to the refrigerator. The cap is unscrewed on the vial labeled B and carefully remove the rubber bung. The cap and the bung can be discarded. The contents of vial A are poured into vial B. Mix them by swirling gently to dissolve. The vial is not shaken. The solution is poured back into bottle A ensuring complete transfer by inverting vial B fully. Vial B is discarded. The screw cap on bottle A is closed until time of testing. A reconstituted enzyme can be stored in the refrigerator at 2° C.-8° C. and used within 24 hours or at normal room temperature (maximum of 25° C.) for up to 12 hours. The reconstituted enzyme and “Extractant” is removed from the refrigerator and given 10 minutes XM to reach ambient temperature.

Before the test is begun, the “Clean-Trace Luminometer” should be switched on and initialized as described in the manual.

Testing Procedure:

1. Pipette 100 mL of sample into a 3M™ Clean-Trace™ Biomass Detection Cuvette (BTCUV).

2. For the Total ATP reading add 100 mL of Extractant XM, mix gently for 2 seconds and stand for a minimum of 60 seconds. For the Free ATP reading add 100 mL of ATP free deionized water. (Check the amount of ATP in the DI water using the procedure for Total ATP prior to testing).

3. Add 100 mL of reconstituted Enzyme from bottle A and mix gently for 2 seconds.

4. Attach a 3M Biomass Detection Cuvette Holder (product code HT2 for Uni-Lite or Uni-Lite XCEL Luminometer or product code NHT01 for the Clean-Trace NG Luminometer) to the cuvette.

5. Immediately open the sample chamber of the Clean-Trace Luminometer and insert the cuvette and cuvette holder. Close the chamber cap and press the measure button. The light emitted by the Clean-Trace test will be measured and the result (in RLU) will appear on the display.

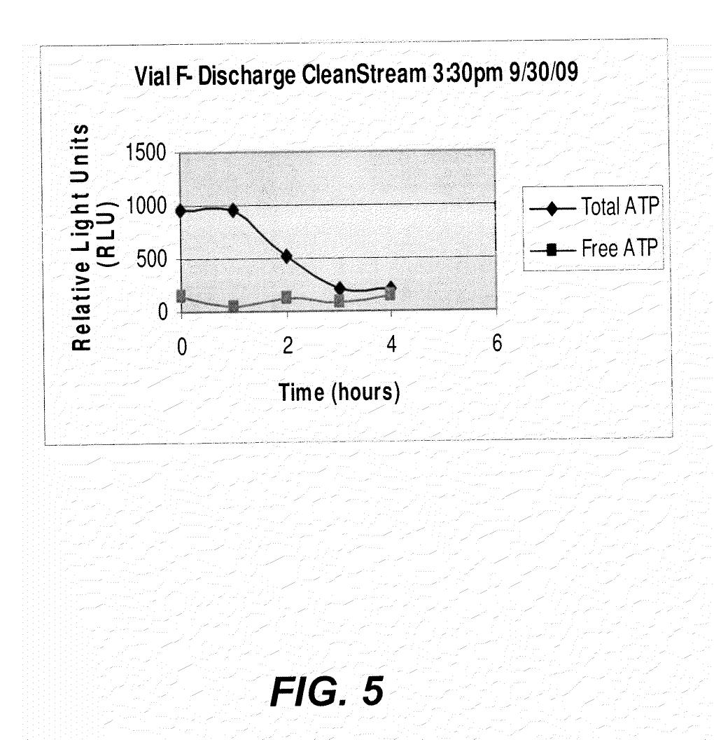

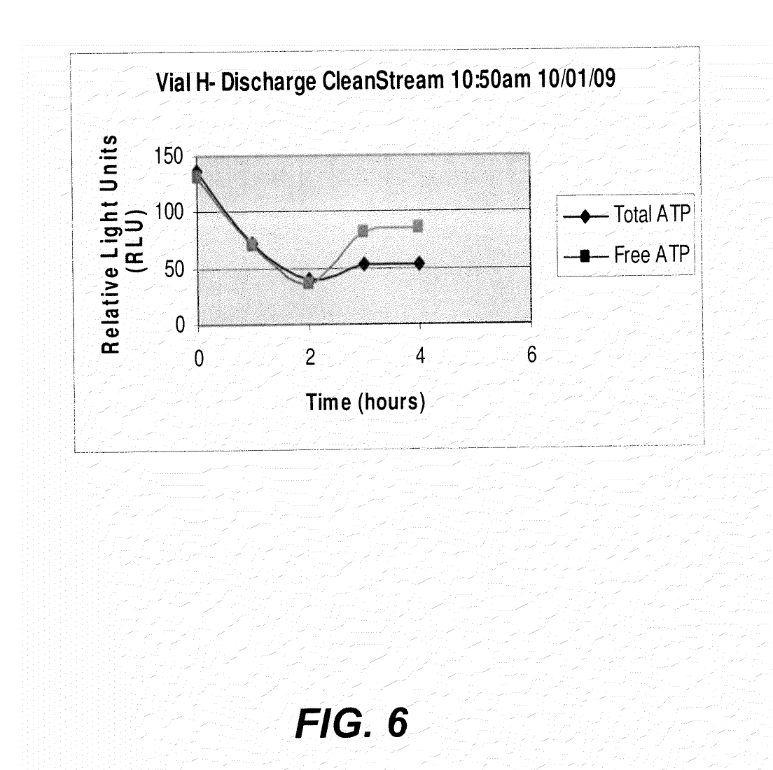

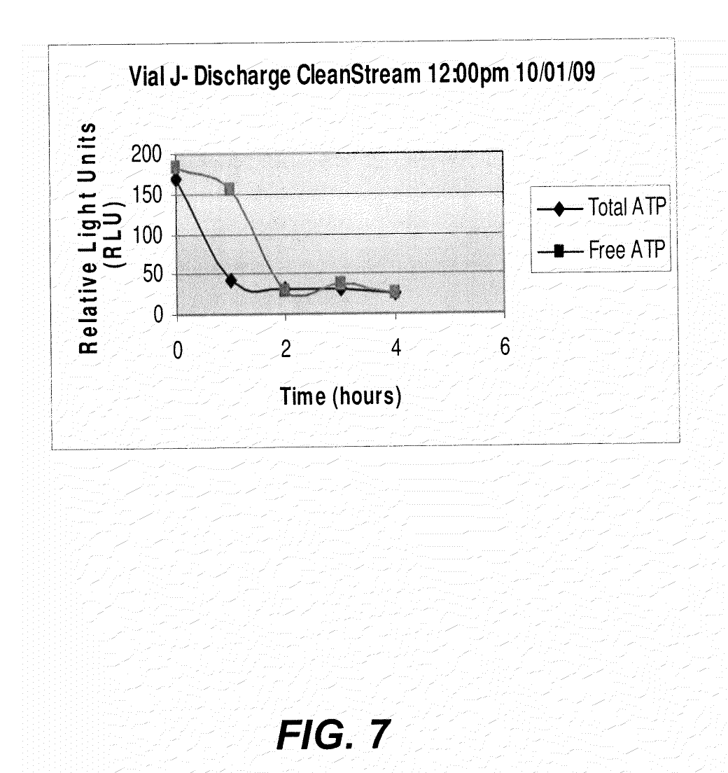

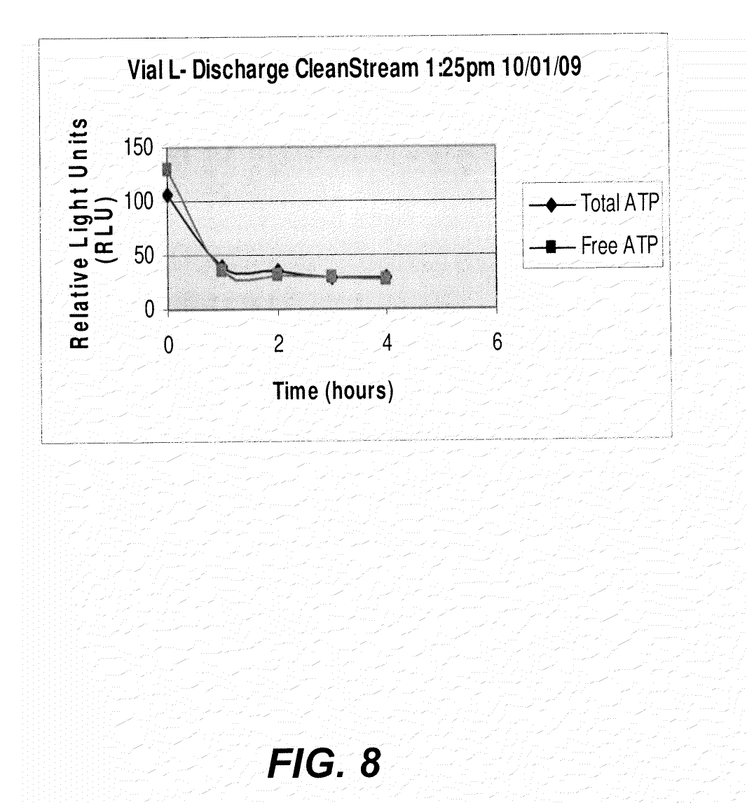

The samples are monitored hourly for four hours. The Free ATP and Total ATP readings are then plotted. As the lines converge that is evidence of a reduction in the bacteria present. FIGS. 3-8 illustrate this convergence.

This testing is conducted on the EOG Hassel #1 in Nacogdoches County, Texas. This particular well had nine stages with a pump time of approximately four hours per stage. The samples described are obtained from only two stages of the job. Samples are collected from the intake side of the UV and the discharge side of the UV about one hour apart. After collecting the samples serial dilutions are performed as well as tests using the 3M biomass detection kit to determine the bacteria counts present. The transmittance (% T) at 254 nm is measured for each sample and a flowrate is obtained which are recorded in Table 3 below. Based on the serial dilution data there is an aerobic bacteria count ranging from 10² to 10⁴ bacteria/mL before the water is treated with the ultra violet light system. After being treated with the ultra violet light system the aerobic bacteria counts decreased to a range of 0 to 10² bacteria/mL. Prior to treatment with the ultra violet light system, the SRB count ranges from 10 to 10² SRB/mL. After being treated with the ultra violet light system the SRB count ranges decreased to levels of 0 to 10 SRB/mL based on the serial dilution tests that are performed. The serial dilution data is summarized in Table 2. A 90% reduction was observed in two samples in the total amount of bacteria present and 99.9% or greater in the other samples.

TABLE 2

| Vial | | Aerobic | Anaerobic | Total |
|---|---|---|---|---|
| Label | Sample | (bacteria/mL) | (bacteria/mL) | (bacteria/mL) |
| A | Intake side CleanStream | 1000 | 10 | 1010 |
| | 30 SEP. 2009 1:30 PM | | | |
| B | Discharge side CleanStream | 0 | 0 | 0 |
| | 30 SEP. 2009 1:30 PM | | | |
| C | Intake side CleanStream | 1000 | 100 | 1100 |
| | 30 SEP. 2009 2:30 PM | | | |
| D | Discharge side CleanStream | 0 | 0 | 0 |
| | 30 SEP. 2009 2:30 PM | | | |
| E | Intake side CleanStream | 1000 | 100 | 1100 |
| | 30 SEP. 2009 3:30 PM | | | |
| F | Discharge side CleanStream | 0 | 0 | 0 |
| | 30 SEP. 2009 3:30 PM | | | |
| G | Intake side CleanStream | 1000 | 100 | 1100 |
| | 1 OCT. 2009 10:50 AM | | | |
| H | Discharge side CleanStream | 100 | 10 | 110 |
| | 1 OCT. 2009 10:50 AM | | | |
| I | Intake side CleanStream | 10000 | 10 | 10010 |
| | 1 OCT. 2009 12:00 PM | | | |
| J | Discharge side CleanStream | 0 | 10 | 10 |
| | 1 OCT. 2009 12:00 PM | | | |
| K | Intake side CleanStream | 1000 | 100 | 1100 |
| | 1 OCT. 2009 1:25 PM | | | |
| L | Discharge side CleanStream | 10 | 0 | 10 |
| | 1 OCT. 2009 1:25 PM | | | |

Testing is also conducted using a ATP luminometer and biomass detection kit. Adenosine Triphosphate or ATP is the cellular energy source. ATP is a high energy molecule that is believed to be unstable due to the closeness of the phosphate groups. By breaking the bond between the second and third phosphate group a large amount of energy is released that is used for cellular process such as flagella movement, protein synthesis, binary fission, etc. The energy from this reaction is used as the driving force in the ATP luminometer. Luciferin and luciferase react with the ATP and will emit light, much like a firefly. This light is detected using the ATP luminometer. Two readings are taken, Total ATP and Free ATP. Total ATP is a measure of all the ATP in the solution; this includes a lysing agent that will rupture any cells releasing the internal ATP in to solution which then allows it to be measured. The Free ATP is a measure of background ATP that is in the solution. This background ATP could be from bacteria that have died and released their contents, algae, fungi, etc. Both the Free and Total ATP readings are taken immediately upon sampling, then hourly for four hours.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. In addition, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
providing a turbid treatment fluid having a first microorganism count;
placing the turbid treatment fluid in a self-contained, road mobile UV light treatment manifold that comprises a UV light source;
irradiating the turbid treatment fluid with the UV light source in the self-contained, road mobile UV light treatment manifold that comprises an attenuating agent so as to reduce the first microorganism count of the turbid treatment fluid to a second microorganism count to form an irradiated treatment fluid, wherein the second microorganism count is less than the first microorganism count; and
placing the irradiated treatment fluid having the second microorganism count in a subterranean formation, a pipeline or a downstream refining process.

2. The method of claim 1 wherein the turbid treatment fluid has 1% to 90% transmittance at 254 nm.

3. The method of claim 1 wherein the turbid treatment fluid comprises a virgin fluid and/or a recycled fluid.

4. The method of claim 1 wherein the first microorganism count is in the range of about 10³ bacteria/mL to about to 10³⁰ bacteria/mL.

5. The method of claim 1 wherein the attenuating agent comprises an organic and/or an inorganic attenuating agent.

6. The method of claim 5 wherein the organic attenuating agent comprises a compound chosen from the group consisting of: acetophenone, propiophenone, benzophenone, xanthone, thioxanthone, fluorenone, benzaldehyde, anthraquinone, carbazole, thioindigoid dyes, phosphine oxides, ketones, benzoinethers, benzilketals, alpha-dialkoxyacetophenones, alpha-hydroxyalkylphenones, alpha-aminoalkylphenones, and acylphosphineoxides, benzophenones, benzoamines, thioxanthones, thioamines, any combination or derivative thereof. These materials may be derivatized to improve their solubility with a suitable derivatizing agent.

7. The method of claim 5 wherein the inorganic attenuating agent comprises a nanosized metal oxide chosen from the group consisting of: nanosized titanium dioxide, nanosized iron oxides, nanosized cobalt oxides, nanosized chromium oxides, nanosized magnesium oxides, nanosized aluminum oxides, nanosized copper oxides, nanosized zinc oxides, nanosized manganese oxides, and any combination or derivative thereof.

8. The method of claim 1 wherein the self-contained, road mobile UV light treatment manifold comprises a thin film of an inorganic attenuating agent.

9. The method of claim 1 wherein the concentration of the attenuating agent is up to about 5% by weight of the turbid treatment fluid.

10. The method of claim 1 wherein the turbid treatment fluid is a flowback treatment fluid.

11. A method comprising:
providing a turbid treatment fluid having a first microorganism count;
placing the turbid treatment fluid in a self-contained, road mobile UV light treatment manifold that comprises a UV light source;
irradiating the turbid treatment fluid with the UV light source in the presence of an attenuating agent to form an irradiated treatment fluid; and
providing the irradiated treatment fluid to a mixing system.

12. The method of claim 11 wherein the turbid treatment fluid has 1% to 90% transmittance at 254 nm.

13. The method of claim 11 wherein the turbid treatment fluid comprises a virgin fluid and/or a recycled fluid.

14. The method of claim 11 wherein the first microorganism count is in the range of about 10³ bacteria/mL to about to 10³⁰ bacteria/mL.

15. The method of claim 11 wherein the attenuating agent comprises an organic and/or an inorganic attenuating agent.

16. The method of claim 15 wherein the organic attenuating agent comprises a compound chosen from the group consisting of: acetophenone, propiophenone, benzophenone, xanthone, thioxanthone, fluorenone, benzaldehyde, anthraquinone, carbazole, thioindigoid dyes, phosphine oxides, ketones, benzoinethers, benzilketals, alpha-dialkoxyacetophenones, alpha-hydroxyalkylphenones, alpha-aminoalkylphenones, and acylphosphineoxides, benzophenones, benzoamines, thioxanthones, thioamines, any combination or derivative thereof. These materials may be derivatized to improve their solubility with a suitable derivatizing agent.

17. The method of claim 15 wherein the inorganic attenuating agent comprises a nanosized metal oxides chosen from the group consisting of: nanosized titanium dioxide, nanosized iron oxides, nanosized cobalt oxides, nanosized chromium oxides, nanosized magnesium oxides, nanosized aluminum oxides, nanosized copper oxides, nanosized zinc oxides, nanosized manganese oxides, and any combination or derivative thereof.

18. The method of claim 11 wherein the self-contained, road mobile UV light treatment manifold comprises a thin film of an inorganic attenuating agent.

19. The method of claim 11 wherein the concentration of the attenuating agent is up to about 5% by weight of the turbid treatment fluid.

20. The method of claim 11 wherein the turbid treatment fluid is a flowback treatment fluid.

21. A mobile UV light treatment fluid treatment system comprising:
an inlet;
a UV light treatment source;
a UV light treatment chamber;
an attenuating agent;
an outlet; and
wherein the UV light treatment fluid treatment system is transported by a self-contained, road mobile platform.
